(19) United States
(12) Patent Application Publication
(10) Pub. No.: US 2017/0002969 A1
(43) Pub. Date: Jan. 5, 2017

(54) METHOD AND APPARATUS FOR LINING PIPES

(71) Applicant: Fyfe Co. LLC, San Diego, CA (US)

(72) Inventors: George Bontus, St. Albert (CA); Charles W. Free, Hernando, MS (US); Jon Whitledge, San Diego, CA (US); Timothy Hann, Parket, CO (US); Rudy Loera, Los Angeles, CA (US)

(21) Appl. No.: 14/790,756

(22) Filed: Jul. 2, 2015

(51) Int. Cl. F16L 55/18; F16L 55/1645

(52) U.S. Cl. CPC F16L 55/18; F16L 55/1645

(57) ABSTRACT

A method and apparatus for lining a host pipe in which a liner is positioned on a carrier tube at a work site. The liner and carrier tube are separately positioned at the work site near a first access point to the host pipe. Ends of the liner and carrier tube are fed through a folding die, and the liner and carrier tube are pulled conjointly through the folding die into the host pipe. As the liner and carrier tube are pulled, the folding die folds the liner to wrap the liner around the carrier tube. In some embodiments, the folding die includes an inner slot for receiving the carrier tube and an outer slot for receiving the liner. The outer slot includes first and second overlapping sections. Portions of the liner received in the overlapping sections are positioned in overlapping engagement as the liner is pulled through the die.

### FIELD

The present invention generally relates to apparatuses and methods for lining pipes and more specifically to apparatuses and methods for installing planar liners in pipes.

### BACKGROUND

Over time or because of a particular event or condition (e.g., seismic activity, exposure to excessive or uneven loads or moments, poor compaction, crown corrosion, corrosive soil, etc.), the structural integrity or capacity of force mains, other pipes, and like structures may diminish. For example, such items may crack, corrode, deteriorate, and the like. Such damage to a pipe is particularly problematic when the pipe is used to carry a high pressure fluid because the pressurization can impart significant forces, particularly in the hoop direction, on the pipe.

Different methods of repairing or otherwise strengthening damaged pipes and other items are known. For example, high strength fabric sections can be attached to one or more portions of a pipe interior. The fabric sections are impregnated with a curable resin or epoxy, attached to the interior surface of a host pipe, and allowed to cure, thereby forming a barrier between the host pipe and the pipe interior. In some conventional cured in place pipe lining applications, a fabric tube of felt or other material is everted or pulled into a pipe. The liner of felt or other material, even when the epoxy carried by the liner is cured, lacks sufficient strength for high pressure applications.

### SUMMARY

In one aspect, a method of lining an interior surface of a host pipe at a work site having a first access point comprises positioning a pliable liner near the first access point. The liner has a first end, a second end, and a length extending between the first and second ends. The liner further has a first longitudinal edge, a second longitudinal edge, and a width extending between the first and second longitudinal edges. A radially expandable carrier tube is positioned near the first access point. The carrier tube has a first end and a second end. A folding die is positioned between the first ends of the liner and carrier tube and the first access point. The folding die is configured to receive the liner and carrier tube therethrough and to fold at least the liner for entry of the liner and carrier tube into the host pipe when the liner and carrier tube are pulled through the folding die. An end portion of the carrier tube adjacent the first end thereof is fed through the folding die. An end portion of the liner adjacent the first end thereof is also fed through the folding die. The liner and carrier tube are pulled conjointly through the folding die and into the host pipe. The folding die folds at least the liner as the liner and carrier tube are being pulled through the folding die. The carrier tube is radially expanded within the host pipe at least until the liner contacts the interior surface of the pipe.

In another aspect, a folding die for folding a liner along a longitudinal axis to wrap the liner around a carrier tube as the liner and carrier tube are being pulled conjointly through the folding die and into a host pipe comprises a die plate having a front face, a rear face opposite the front face, and a thickness extending between the front face and rear face. The plate has an elongate inner slot and an elongate outer slot extending through the thickness of the plate from the front face through the rear face. The outer slot extends around the inner slot from a first end to a second end opposite the first end and has a first overlapping section adjacent the first end and a second overlapping section adjacent the second end. The first overlapping section overlaps the second overlapping section such that the second overlapping section is positioned between the first overlapping section and the inner slot. The inner slot is configured to receive the carrier tube therethrough, and the outer slot is configured to receive the liner therethrough such that a first overlapping portion of the liner is received in the first overlapping section of the outer slot and a second overlapping portion of the liner is received in the second overlapping section of the outer slot. The folding die is configured to wrap the liner around the carrier tube and position the first overlapping portion of the liner in overlapping engagement with the second overlapping portion of the liner as the liner and carrier tube are pulled conjointly through the folding die and into the host pipe.

Other objects and features will be in part apparent and in part pointed out hereinafter.

### BRIEF DESCRIPTION OF THE DRAWINGS

FIG. 1 is a schematic elevation of a pipe liner preparation system positioned adjacent a host pipe;

FIG. 1A is a fragmentary perspective of a carrier tube;

FIG. 1B is a perspective of a liner in a laid flat condition;

FIG. 2A is a cross-sectional schematic of a liner and carrier tube inserted into the host pipe with the carrier tube being uninflated;

FIG. 2B is a cross-sectional schematic of the liner and carrier tube inserted into the host pipe with the carrier tube being partially inflated;

FIG. 2C is a cross-sectional schematic of the liner and carrier tube installed in the host pipe;

FIG. 3 is an enlarged schematic elevation of a portion of the pipe liner preparation system and host pipe with the liner and carrier tube extending through the pipe liner preparation system;

FIG. 3A is a cross-sectional schematic of the host pipe with coupling members and sacrificial end tubes positioned adjacent each of the ends of the host pipe;

FIG. 4 is a perspective of a folding system of the pipe liner preparation system with the liner and carrier tube extending through the folding system;

FIG. 5 is a perspective of an upstream folding die of the folding system;

FIG. 6 is a perspective of the upstream folding die with the liner and carrier tube extending therethrough;

FIG. 7 is a perspective of an intermediate folding die of the folding system;

FIG. 8 is a perspective of the intermediate folding die with the liner and carrier tube extending therethrough;

FIG. 9 is a perspective of a downstream folding die of the folding system;

FIG. 10 is a perspective of the downstream folding die with the liner and carrier tube extending therethrough;

FIG. 11 is a perspective of the downstream folding die with a spacer installed in an outer slot; and

FIG. 12 is a perspective of a downstream folding die with a roller installed in an outer slot.

Corresponding reference characters indicate corresponding parts throughout the drawings.

### DETAILED DESCRIPTION

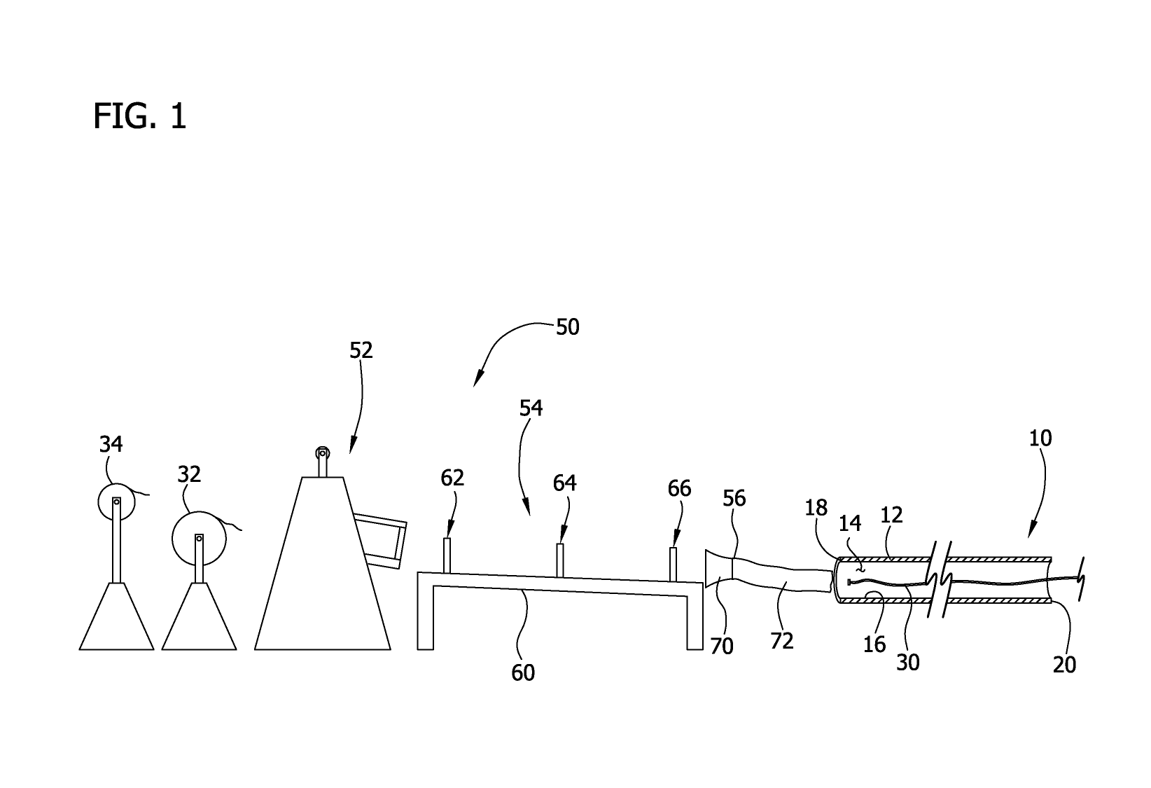

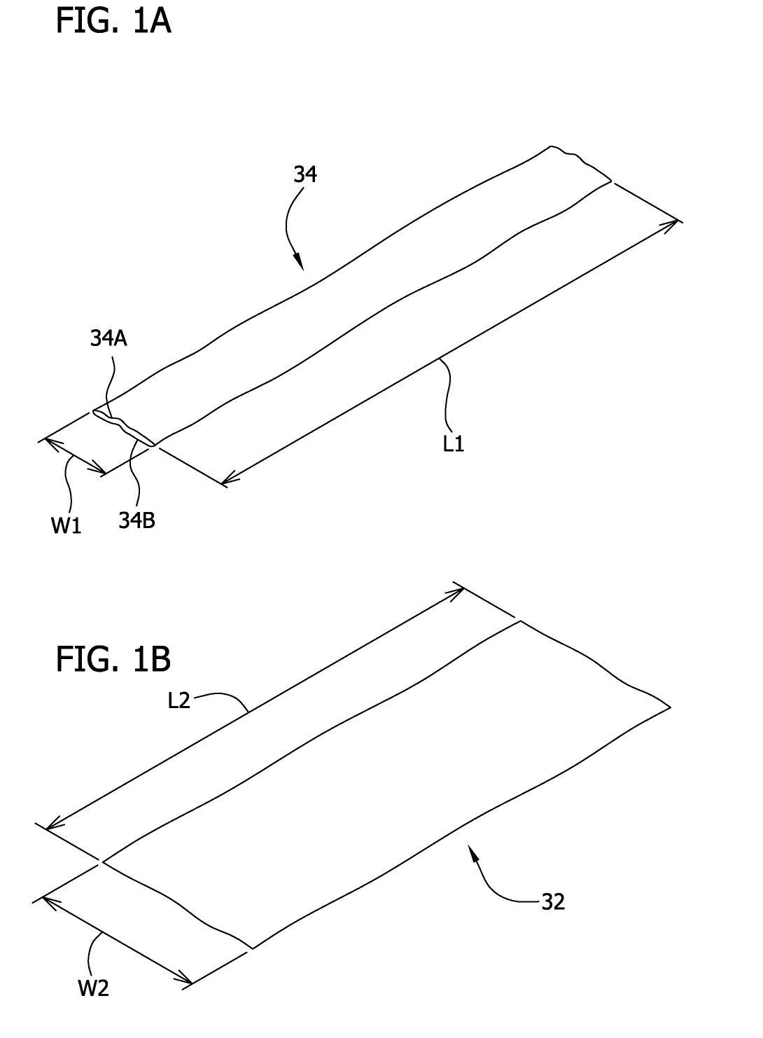

Referring to FIG. 1, a host pipe that needs lining is generally indicated at reference number 10. Although FIG. 1 does not illustrate the context of the host pipe 10, the host pipe may be a high pressure pipe in an industrial processing facility. The host pipe 10 may also be another type of pipe installed in another field application. Moreover, the pipe may be above ground, as shown, or underground. The host pipe 10 has a wall 12 extending in a hoop direction around an interior lumen 14. In some embodiments, the host pipe 10 is sized so the interior lumen has a diameter less than or equal to about 14 inches (35.56 cm). Human installers are unable to enter host pipes of this size, so pipe lining materials must be introduced into the lumen in other ways, such as pull-in or eversion. Other sizes of host pipes may also be used without departing from the scope of the invention. The wall 12 has deteriorated such that it may be unfit to carry high pressure fluid and, accordingly, is in need of lining. An interior surface 16 of the pipe 10 defines the interior lumen 14 in FIG. 1. As will be apparent, the methods, systems, and apparatuses described in detail below enable a liner made from a planar sheet of pliable fabric material to be installed in the host pipe 10.

The host pipe wall 12 extends in a longitudinal direction between two access points 18, 20 separated by a distance. In the illustrated embodiment, the access points 18, 20 are at open ends of the host pipe 10 where a pipe liner installer may access the interior lumen 14. An installer may also access the interior lumen of a host pipe in other ways (e.g., through lateral access tubes, etc.). In some instances, the open end of the pipe is accessed from a manhole, or a pit dug in the ground. A pull rope 30 extends through the host pipe 10 from the first access point 18 to the second access point. As will be discussed in further detail below, the pull rope 30 pulls a liner 32 (FIG. 1B) and carrier tube 34 (FIG. 1A) conjointly into the interior lumen 14 of the host pipe 10, and the carrier tube subsequently expands the liner until it contacts the interior surface 16. The pull rope 30 is illustrated schematically in FIG. 1 with a free end that is not yet attached to the liner 32.

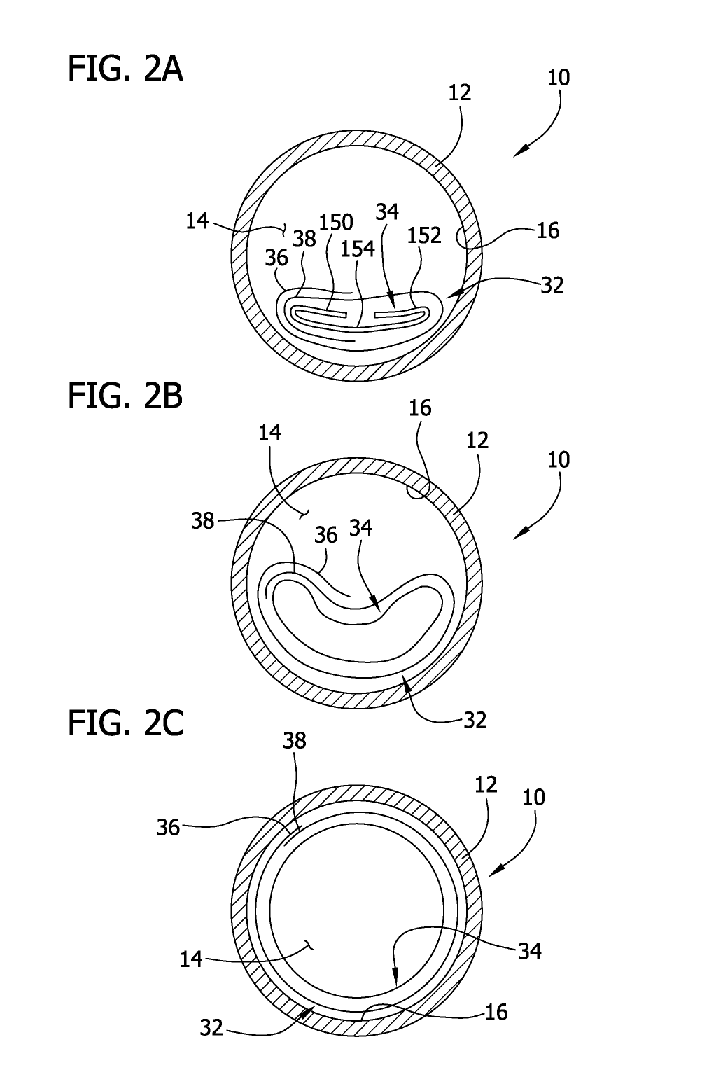

As shown in FIG. 1A and FIGS. 2A-2C, the carrier tube 34 is an expandable tube. Referring specifically to FIG. 1A, the carrier tube 34 can be flattened. When the carrier tube 34 is flattened, it has a top portion 34A and a bottom portion 34B that meet at longitudinal edges of the flattened carrier tube. The carrier tube 34 has a width W1 that extends between the folded longitudinal edges and a length L1 that extends between opposite longitudinal ends. As shown in FIG. 1, the flattened carrier tube 34 may be wound onto a roll about an axis perpendicular to the length L1 of the carrier tube. The carrier tube 34 may be made from any suitable material. But in a preferred embodiment, the carrier tube is a laminate of a thin felt material and a polyurethane or polypropylene film, although other materials may be used within the scope of the present invention. Preferably the carrier tube 34 will be made from a radially expandable material (e.g., a material that is stretchable in the hoop direction).

As shown in FIGS. 2A-2C, the carrier tube 34 is configured to expand within the host pipe 10 from a generally flat, folded-over configuration (FIG. 2A) to an expanded configuration (FIG. 2C) to hold the liner 32 against the interior surface 16 of the host pipe 10. In some embodiments, the length L1 of the carrier tube is equal to or greater than the distance between the access points 18, 20 to the host pipe 10 so that the carrier tube can expand the liner 32 to contact the interior surface 16 along the length of the host pipe between the two access points. In the illustrated embodiment, the carrier tube 34 remains fixed to the liner 32 after the liner is installed in the host pipe 10. Thus, the carrier tube 34 forms the interior surface of the host pipe 10 after the liner 32 is installed. The carrier tube 34 may comprise a material that, once it is fixed to the liner in the host pipe 10, has a desired surface texture (e.g., smooth) for the lined pipe. Although the carrier tube 34 remains fixed to the liner 32 after installation in the illustrated embodiment, the carrier tube may also be removed after the liner is installed without departing from the scope of the invention.

The carrier tube 34 is a “universal” carrier tube in that it may carry any suitable type of liner 32 into a host pipe 10 and expand the liner radially outwardly to contact the interior surface 16. A universal carrier tube 34 may function as a carrier for different types of liners 32, without significantly affecting the mechanical properties of the lined host pipe 10. By comparison, liner 32 provides reinforcement to the host pipe 10 and has mechanical properties suitable for the host pipe application. In some embodiments, the carrier tube 34 could have mechanical properties (e.g., watertightness, reinforcing strength, etc.) that enhance the resulting lined pipe 10.

Referring to FIG. 1B, the liner 32 is a planar sheet of fabric sized for lining the host pipe 10. The liner 32 is a single sheet that has opposite first and second ends and a length L2 extending along a longitudinal axis of the liner between the first and second ends. The liner 32 also has a first longitudinal edge, a second longitudinal edge opposite the first longitudinal edge, and a width W2 extending along a lateral axis of the liner from the first longitudinal edge to the second longitudinal edge. The length L2 of the liner 32 is preferably as long as the distance between the two access points 18, 20 of the host pipe 10 so that the liner can line the entire length of the host pipe between the two access points. As shown in FIG. 2C, the width of the liner 32 is preferably slightly longer than the hoop dimension of the interior surface 16 of the host pipe 10 so that, when the liner is installed in the host pipe, the liner covers the entire circumference of the interior surface 16, with a first overlapping portion 36 of the liner adjacent the first longitudinal edge overlapping a second overlapping portion 38 of the liner adjacent the second longitudinal edge. In a preferred embodiment, the overlapping portions 36, 38 of the liner 32 have a width of about 1.0-times the diameter of the host pipe 10. Since the circumference of the host pipe 10 is equal to π-times the diameter of the host pipe, in this embodiment, the liner has a width W2 equal to (π+1)-times the diameter of the host pipe. In certain preferred embodiments, the overlapping portions 36, 38 of the liner 32 have a width of from about 0.5-times the diameter of the host pipe 10 to about 1.5-times the diameter of the host pipe. The width of the overlapping portions can have other dimensions without departing from the scope of the invention.

The liner 32 is a pliable fabric material that enhances the mechanical characteristics of the host pipe 10 when installed in the host pipe. As shown in FIG. 1, like the carrier tube 34, the liner 32 can be wound onto a roll. As shown in FIG. 2A, the liner 32 is foldable along at least one longitudinal fold axis so that the liner may be wrapped around the carrier tube 34. In certain embodiments, the liner 32 is a structural liner comprising high strength fibers, which strengthen the host pipe when the liner is installed. Likewise, the liner 32 may form a watertight or fluid-tight barrier between the host pipe 10 and the interior lumen 14 when installed in the host pipe. In the illustrated embodiment, the liner 32 is configured to be impregnated with a curable polymeric material prior to entry into the host pipe 10. As will be discussed in further detail below, the curable material cures as the carrier tube 34 holds the liner 32 against the interior surface 16 of the host pipe 10 and may bond the liner to the host pipe wall 12 and to the carrier tube. In a suitable embodiment, the liner 32 is constructed as described in U.S. patent application Ser. No. 14/690,265, which is assigned to the assignee of the present invention, and the disclosure of which is incorporated by reference into the present disclosure

One way of installing the liner 32 and carrier tube 34 will now be described in reference to a liner and carrier tube that are shaped for installation in the host pipe 10 using preparation techniques described in further detail below. In part, the preparation techniques described below function to shape the liner 32 and carrier tube 34 for installation in the host pipe 10 using the installation techniques described here. It will be understood that other installation techniques may be used without departing from the scope of the invention and that the preparation techniques described in further detail below may be adapted to suit such other installation techniques. As illustrated in FIG. 2A, the liner 32 and carrier tube 34 are preferably positioned in the interior lumen 14 of the host pipe 10 between the two access points 18, 20 when the liner is folded into a “pull-in configuration” in which the width W2 of the liner wraps around the carrier tube 34. The folded liner 32 and carrier tube 34 are preferably configured so that, when a pressurized fluid is introduced into the carrier tube, the carrier tube expands radially outwardly, as shown in FIGS. 2B-2C, and expands the liner radially outwardly until it contacts the interior surface 16 of the host pipe 10. The overlapping portions 36, 38 of the liner 32 are largest in the initial folded configuration illustrated in FIG. 2A, before the carrier tube expands radially outwardly. As the carrier tube 34 expands, the first overlapping portion 36 slides along the outer surface of the second overlapping portion 38, reducing the amount of overlap between the first and second overlapping portions, until the liner contacts the interior surface 16 of the host pipe 10. A smaller amount of overlap between the overlapping portions 36, 38 remains after the liner 32 is fully expanded and fully installed.

Referring again to FIG. 1, a liner preparation system for preparing the liner 32 and carrier tube 34 for installation in the host pipe 10 is generally indicated at reference number 50. The liner preparation system 50 includes a wet out system, generally indicated at reference number 52, and a folding system, generally indicated at reference number 54. As will be discussed in further detail below, the illustrated wet out system 52 is configured to load the liner 32 with curable epoxy just prior to installation in the host pipe 10 at a location near the first access point 18 to the host pipe. The folding system 54 is configured to shape the liner 32 and carrier tube 34 for being pulled into the host pipe 10 at a location near the first access point 18 of the host pipe.

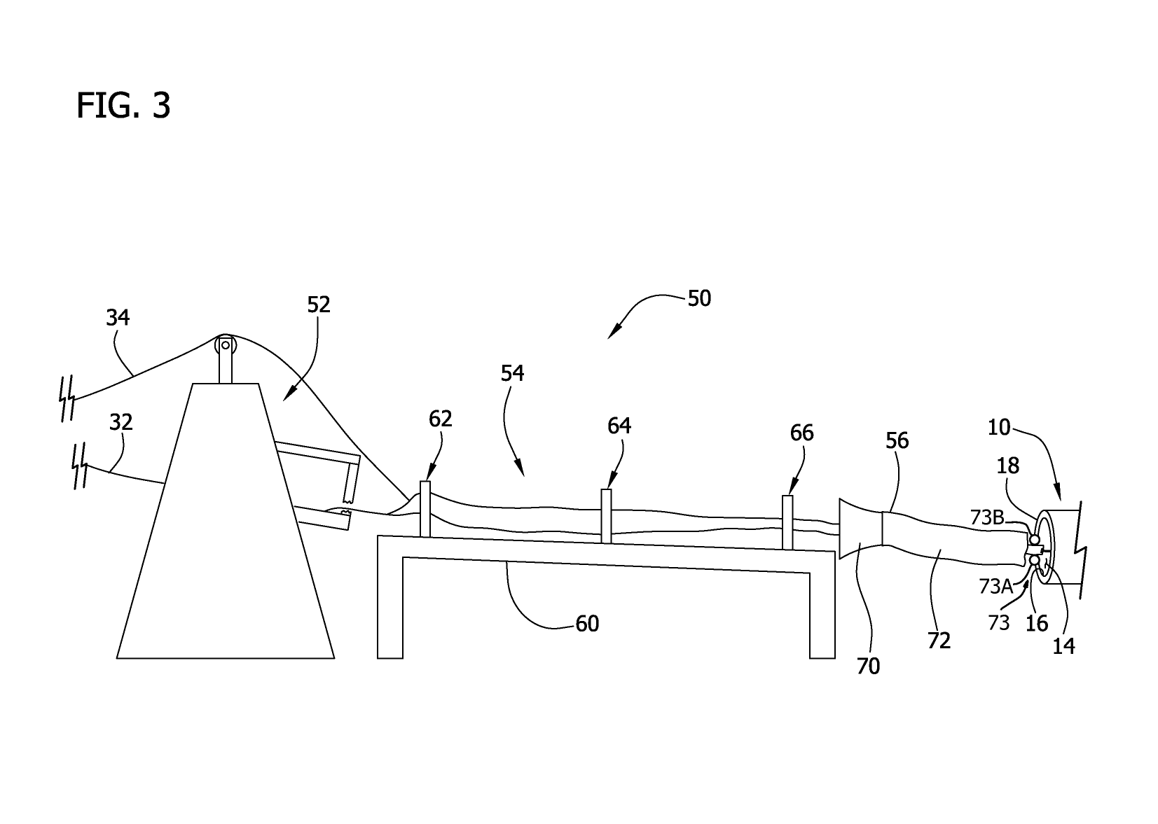

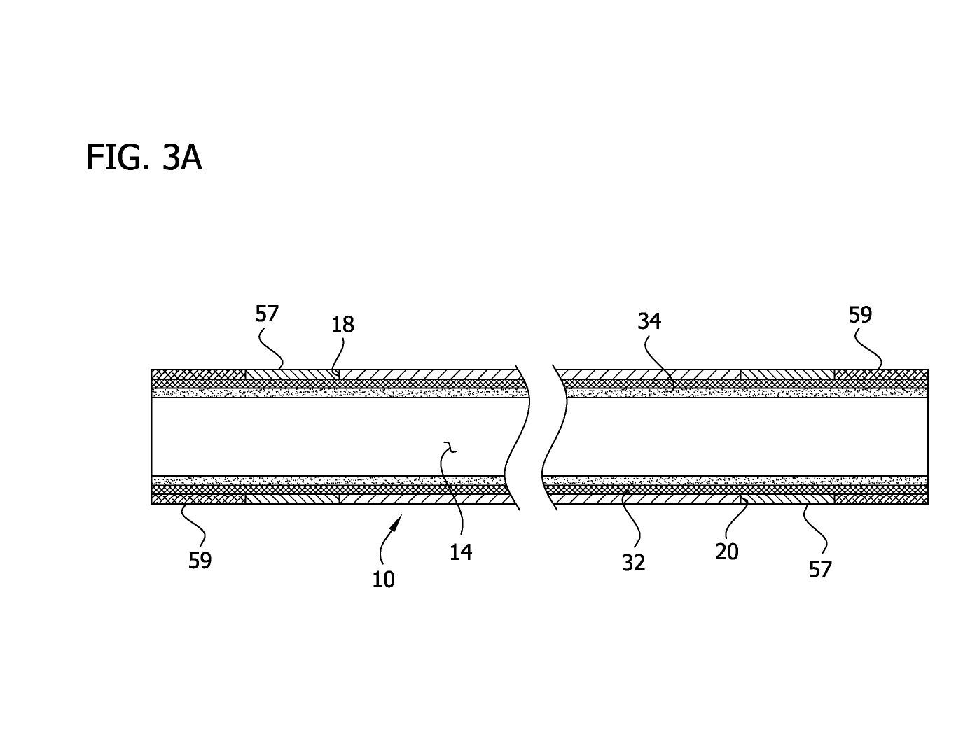

In use, the liner preparation system 50 is positioned at the work site, near the first access point 18 to the host pipe 10. More specifically, a roll containing the liner 32 and a roll containing the carrier tube 34 are positioned near the first access point 18, the wet out system 52 is positioned between free ends of the liner and carrier tube and the first access point, and the folding system 54 is positioned between the wet out system (and free ends of the liner and carrier tube) and the first access point. As shown in FIG. 3, once the components of the installation system are in position, the free ends of the liner 32 and carrier tube 34 are fed through the wet out system 52 and folding system 54, before passing through a guide chute 56, which directs the liner and carrier tube into the interior lumen 14 of the host pipe 10. As illustrated, the guide chute 56 ends just short of the access point 18 of the host pipe 10. The pull rope 30 is attached to the free ends of the liner 32 and carrier tube 34 by way of a suitable fitting (not shown) to pull the liner and carrier tube conjointly into the host pipe 10. The pull rope 30 pulls the liner 32 and carrier tube 34 through the wet out system 52, folding system 54, and into the host pipe 10 at the same time.

As shown in FIG. 3, prior to being inserted into the host pipe 10, the liner 32 extends into and through the wet out system 52. The wet out system 52 impregnates the liner with a curable epoxy. In a preferred embodiment, the curable epoxy is Tyfo® S epoxy, which is sold by the assignee of this invention or other epoxies that are sold by the assignee of the invention. In one or more embodiment, the wet out system 52 impregnates the liner 32 with a curable resin that cures to form a moisture tolerant and high temperature tolerant polymer. The wet out system 52 may load the liner 32 with other types of epoxies, or other curable polymeric materials, without departing from the scope of the invention. The wet out system 52 may be any suitable system for impregnating the liner 32 with curable polymeric material. Other ways of loading curable polymeric material onto a liner (e.g., manual loading) may also be used without departing from the scope of the invention. In the illustrated embodiment, the carrier tube 34 bypasses the wet out system 52. No curable polymeric material is loaded onto the carrier tube 34 prior to the carrier tube contacting the liner 32. But after the carrier tube 34 contacts the liner 32 within the host pipe 10 and the epoxy in the liner cures, the epoxy bonds the carrier tube to the liner. However, curable polymeric material may be applied to the carrier tube 34 prior to contact with the liner 32.

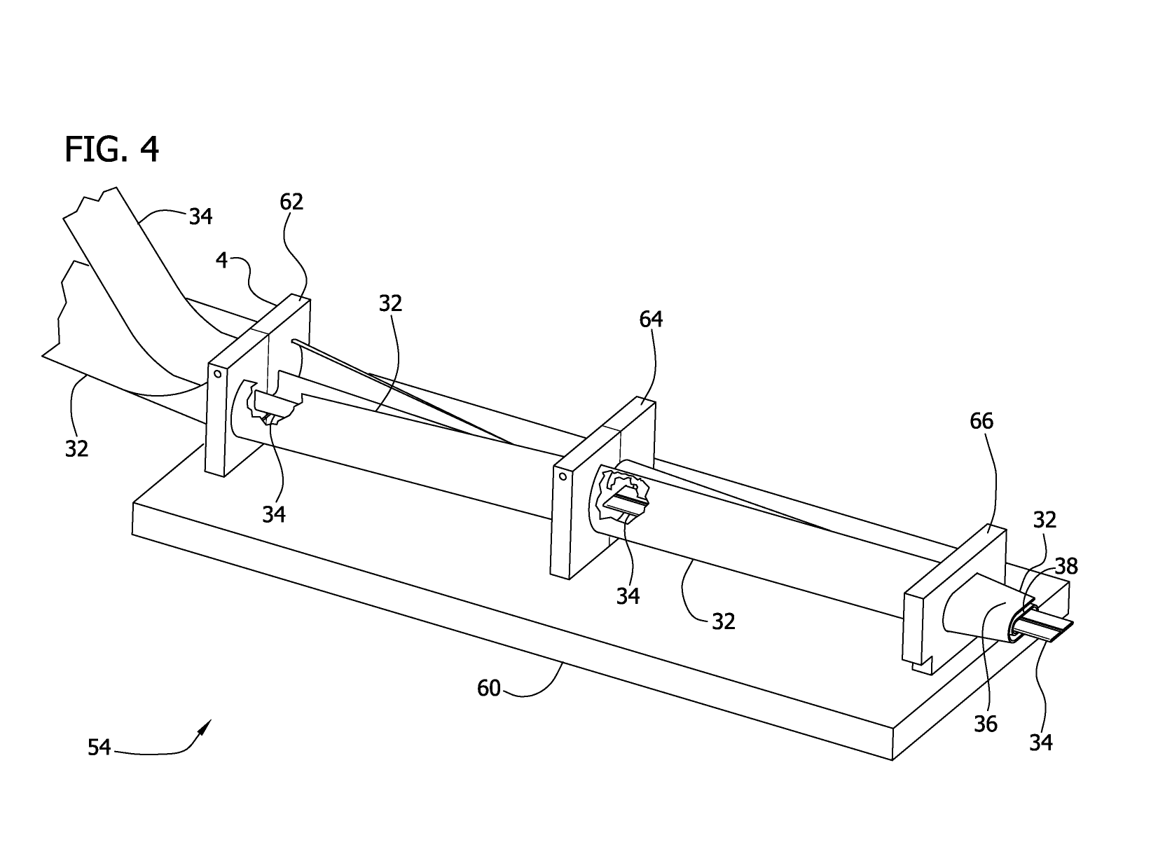

Referring to FIGS. 3 and 4, the folding system 54 generally functions to fold the liner 32 and carrier tube 34 to shape the liner and carrier tube for being pulled into the host pipe 10. In the illustrated embodiment, the folding system 54 includes a sloped table 60 that supports an upstream folding die 62, an intermediate folding die 64, and a downstream folding die 66. The height of the table 60 is preferably adjustable to raise and lower at least the downstream end of the table to vertically align the downstream end of the table with the first access point 18 to the host pipe 10, as nearly as possible given the physical constraints of the environment of the host pipe.

Occasionally, physical constraints of the location of the host pipe 10 in the field require the downstream end of the table 60 to be spaced apart from the first access point 18. As shown in FIG. 3, the guide chute 56 provides a way of guiding the liner 32 and carrier tube 34 from the downstream end of the table 60 to the first access point 18. In the illustrated embodiment, the guide chute 60 includes a rigid funnel 70 that is mounted on the table 60 adjacent the third folding die 66 and a flexible tube 72 that extends from the small end of the funnel to adjacent the first access point 18. The funnel 70 and tube 72 protect the liner 32 and carrier tube 34 from dirt and other foreign materials as the liner and carrier tube pass from the third folding die 66 to the host pipe 10. The rigid funnel 70 and/or flexible tube 72 may be omitted within the scope of the present invention.

In one or more embodiments, an optional roller pair 73 (shown schematically in FIG. 3) is positioned just upstream of the first access point 18 to the host pipe 10. The roller pair 73 preferably includes a horizontally oriented first cylindrical roller 73A and a parallel second cylindrical roller 73B spaced apart to receive the folded liner 32 and carrier tube 34 therein after the liner and carrier tube exit the folding system 54. The rollers 73A, 73B are preferably spaced from one another so as to hold the liner 32 and carrier tube 34 in a folded configuration as the liner and carrier tube enter the host pipe 10 through the first access point.

Referring to FIG. 3A, in certain embodiments, the pipe lining system 50 includes terminal coupling members 57 for coupling the ends of the lined host pipe 10 to other pipes or fluid transporting structures. The terminal coupling members 57 comprise tubes of metal, fiber reinforced polymer, or other suitable material that are configured to receive end portions of the liner 32 and carrier tube 34. The liner 32 attaches the coupling members 57 to the lined pipe 10. The coupling members 57 are also configured to be joined with respective mechanical couplers (not shown), which couple the coupling members to other sections of pipe (not shown). In some embodiments, the coupling members 57 can include lateral tubes and or flanges for coupling the coupling members to other pipes. The coupling members 57 can have the same interior and exterior dimensions as the host pipe 10, or they can have different dimensions without departing from the scope of the invention. The coupling members 57 are preferably formed from a rigid or semi-rigid material that can withstand the forces imparted thereupon by a mechanical coupler joining the coupling members to other pipe segments. In an exemplary embodiment, the interior surfaces of the coupling members 57 are prepared to promote adhesive bonding with the curable epoxy in the liner 32. For example, the coupling member 57 could be prepared by cleaning, abrading, grinding, etc.

Referring still to FIG. 3A, in some embodiments, the pipe lining system 50 can also include one or two sacrificial end tubes 59. Like the host pipe 10 and the coupling members 57, the sacrificial end tubes 59 are configured to be lined with the liner 32 and carrier tube 34. Unlike the host pipe 10 and coupling members 57, the sacrificial end tubes 59 are configured to be removed after lining is complete. Preferably, the sacrificial end tubes 59 are made from an inexpensive material. For example, in some embodiments, the sacrificial end tubes are formed from cardboard. It is believed that, with the pipe lining system 50, wrinkles in the resulting liner are more likely to form near where the liner 32 transitions into the host pipe 10. The sacrificial end tubes 59 have an internal diameter that is about the same as that of the host pipe 10 and the coupling members 57. The end tubes 59 are configured to be positioned end to end with the ends of the host pipe 10 or, as illustrated in FIG. 3A, with the ends of the coupling members 57. After a liner 32 is installed in the host pipe 10, coupling members 57, and sacrificial end tubes 59, wrinkles at the end portions of the resulting liner are located in the sacrificial end tubes 59, rather than the host pipe 10 or the coupling members 57. After the carrier tube 34 has been radially expanded and the liner 32 has cured, the sacrificial end tubes 59 can be removed, thereby removing any wrinkled end portion of the resulting liner.

The use of the coupling members 57 and sacrificial end tubes 59 will now be described. Although the coupling member 57 and end tubes 59 are described together, it will be understood that terminal coupling members can be used without sacrificial end tubes and sacrificial end tubes can be used without terminal coupling members without departing from the scope of the invention. The terminal coupling members 57 are positioned generally end to end with the ends of the host pipe 10 before pulling the liner 32 and carrier tube 34 into the host pipe. Likewise, the sacrificial end tubes 59 are positioned generally end to end with the host pipe 10 (if no coupling members 57 are being used) or with the coupling members. For example, in the illustrated embodiment, an end of each of the coupling members 57 abuts the respective outer end of the host pipe 10, and an end of each of the end tubes 59 abuts the outer end of the respective coupling member 59. In other embodiments, the coupling members 57 and end tubes 59 are positioned generally end to end with one another and with the host pipe 10 in other arrangements (e.g., an end portion of one tube can be received within the end portion of an adjacent tube, two adjacent tube ends could be slightly spaced from one another, etc.). When the coupling members 57 and end tubes 59 are properly positioned, the interiors of the coupling members and end tubes are preferably generally aligned with the lumen 16 of the host pipe 10. One or more technicians may manually position the coupling members 57 and end tubes 59, or the technicians may use a positioning clamp or other positioning device.

The interior surface of the coupling members is preferably prepared to promote adhesive bonding with the liner 32 prior to installing the liner and carrier tube 34 in the host pipe 10. For example, the pipe lining technicians preferably clean and abrade the interior surface to enhance adhesive bonding with the liner 32. Likewise, the pipe lining technicians preferably apply a curable polymeric material to the interior surface of the coupling members 75 before installing the liner 32. The technicians may prepare the interior surfaces of the coupling members 57 before or after positioning the coupling member generally end to end with the host pipe 10.

With the coupling members 57 and end tubes 59 in the proper position, the pipe lining technicians next install the liner 32 and carrier tube 34. After impregnating the liner 32 with curable epoxy, the pull rope 30 pulls the liner and carrier tube 34 into the host pipe 10 so that the liner and carrier tube extend through each of the coupling members 57, the sacrificial end tubes 59, and the host pipe 10. The pipe lining crew radially expands the carrier tube 34 until the liner 32 contacts the interior surface of the coupling members 57, the sacrificial end tubes 59, and the host pipe 10. The epoxy cures and bonds the liner 32 with the coupling members 57, thereby attaching the coupling members to the host pipe 10. After the curable epoxy has cured, the sacrificial end tubes 59 are cut away along with the portions of the liner 32 and carrier tube 34 received therein. The length of each end tube 59 is selected so as to achieve full transition to the interior diameter of the host pipe 10 within the end tube. As a result, any wrinkles that form on the end portions of the liner 32 and carrier tube 34 should be localized to the sacrificial end tubes so that the portions of the liner and carrier tube that remain after the sacrificial end tubes are removed are substantially free of wrinkles. Mechanical couplers can be used to join the coupling members 57 to other pipe segments, thereby coupling the lined host pipe 10 to other pipes.

Referring to FIG. 4, the folding dies 62, 64, and 66 progressively fold the liner 32 and carrier tube 34 for entry into the host pipe 10 as the pull rope 30 pulls the liner and carrier tube conjointly through the folding dies and into the host pipe. After the liner 32 has passed through the wet out system 52, it has a generally linear, unfolded cross-sectional shape. Similarly, after the carrier tube 34 has bypassed the wet out system 52, it has the shape of a flattened tube. From this initial configuration, the free ends of the liner 32 and carrier tube 34 are each manually fed through the upstream folding die 62, the intermediate folding die 64, and, finally, the downstream folding die 66. As will be discussed in further detail below, each folding die folds the liner 32 and carrier tube 34 in succession toward the folded pull-in configuration illustrated in FIG. 2A. At the downstream end of the downstream folding die 66, the liner 32 and carrier tube 34 are shaped in the pull-in configuration (i.e., shaped for being pulled through the host pipe 10). Once the free ends of the liner 32 and carrier tube 34 have been manually inserted through the downstream folding die 66, they can be inserted through the guide chute 56 and attached to the pull rope 30. It will be understood that the pull rope 30 can also be passed through the guide chute 56 in the upstream direction and attached to the free ends of the liner 32 and carrier tube 34 at the downstream end of the table 60.

An exemplary construction for each of the folding dies 62, 64, 66 will now be described. The illustrated construction of the folding dies 62, 64, 66 folds the liner 32 and carrier tube 34 into the folded pull-in configuration shown in FIG. 2A. More specifically, the folding dies 62, 64, 66 progressively wrap the liner 32 about the folded carrier tube 34. The folded configuration of FIG. 2A facilitates entering the pipe 10 and helps to reduce drag as the liner 32 and carrier tube 34 are pulled through the host pipe 10. Other folding die constructions designed for folding the liner 32 and/or carrier tube 34 into other folded configurations may also be used without departing from the scope of the invention. Although the illustrated embodiment uses three folding dies 62, 64, 66 to fold the liner 32 and carrier tube 34 for entry into the host pipe 10, it will be understood that other folding systems can use sets of folding dies having more or fewer than three folding dies without departing from the scope of the invention. Moreover, it is to be understood that the folding system 54 could be eliminated within the scope of the present invention.

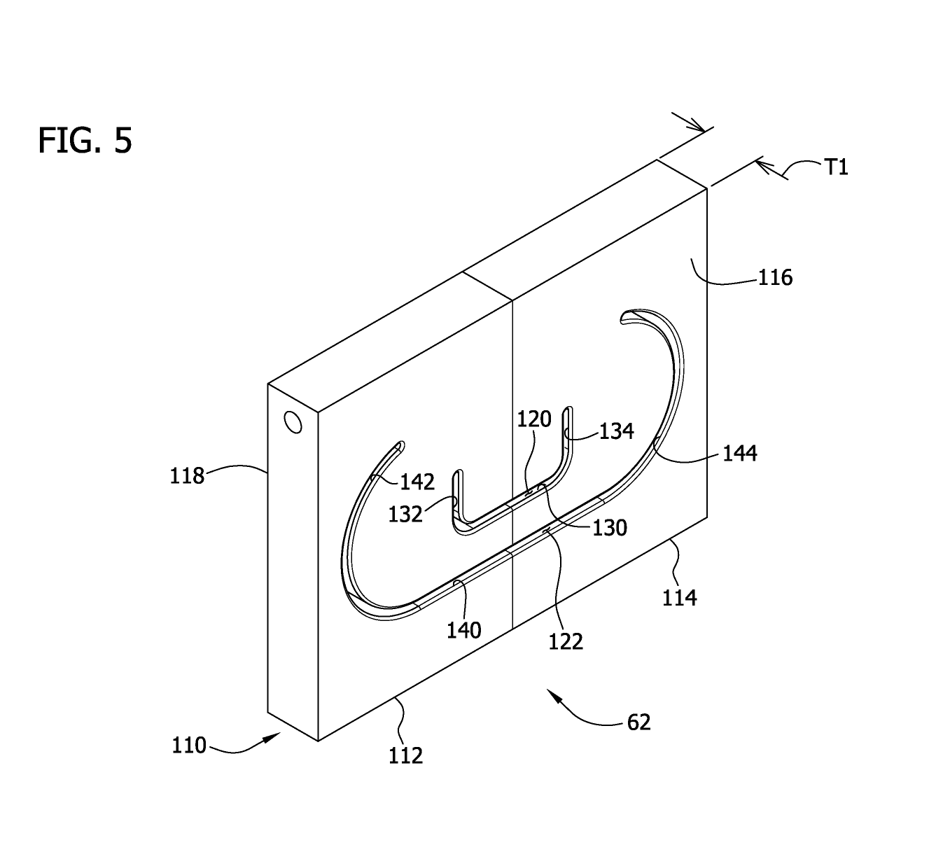

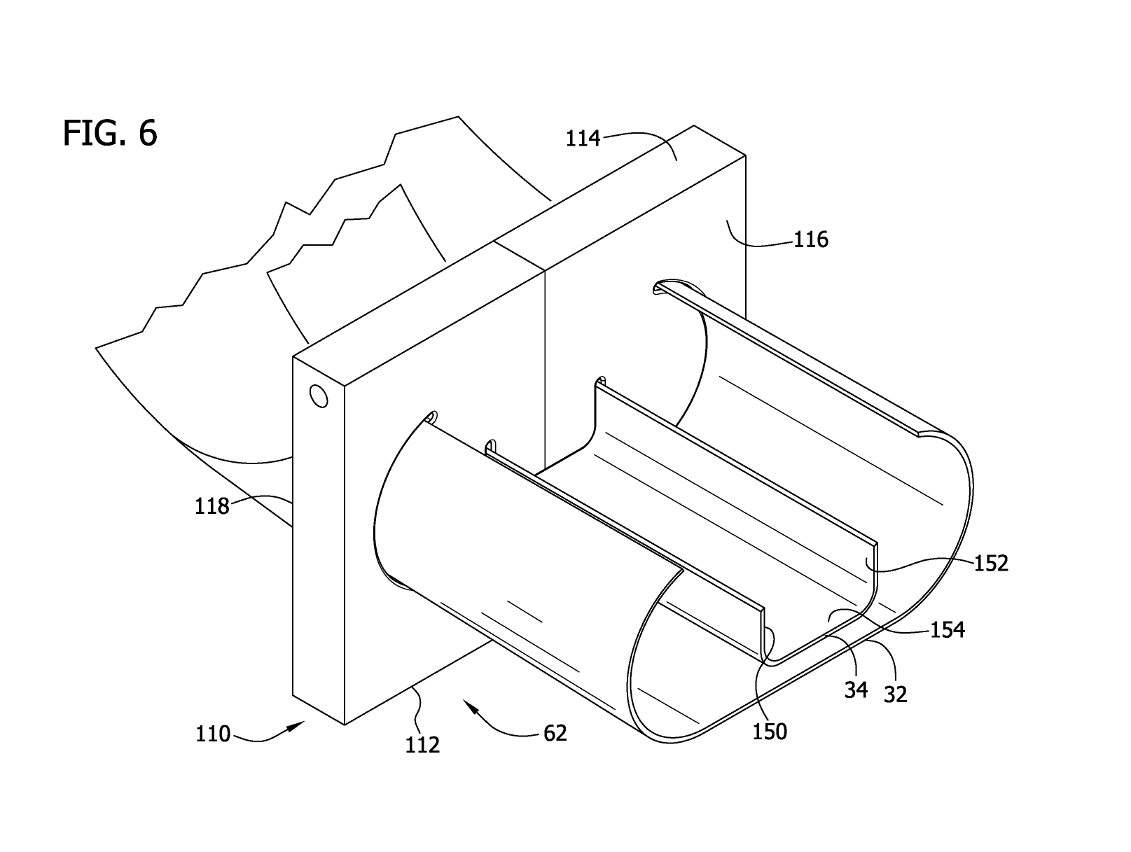

Referring to FIGS. 5-6, the upstream folding die 62 is configured to receive the liner 32 and carrier tube 34 from the wet out system 52 and to fold each of the liner and carrier tube into a U-shaped configuration. The upstream folding die 62 includes a die plate 110 comprising first and second releasably attachable plate members 112, 114. The plate members 112, 114 are selectively attachable to each other to form the die plate 110. The plate members 112, 114 may also be separated from one another to aid in initially inserting the liner 32 and carrier tube 34 into the folding die 62. It will be understood that the upstream die plate could be constructed of other numbers of plate member (e.g., one or more) without departing from the scope of the invention.

When the plate members 112, 114 are attached to one another to form the die plate 110, the die plate has a front face 116 (which faces in the downstream direction in FIG. 4), a rear face 118 (which faces in the upstream direction in FIG. 4) opposite the front face, and a thickness T1 extending between the front and rear faces. The die plate 110 can be made from any suitable material, including aluminum, polyethylene, steel, and other suitable polymeric or metallic materials. The die plate 110 has an elongate inner slot 120 and an elongate outer slot 122 extending through the thickness T1 of the plate from the front face 116 through the rear face 118. The inner slot 120 is sized and shaped to receive the carrier tube 134 therethrough. The inner slot 120 preferably has a length that is slightly longer than the width W1 of the carrier tube in the flattened tube configuration. For example, in one embodiment the inner slot 120 has a length that is about 105% of the width W1 of the carrier tube 34. The inner slot 120 can also be a different length (e.g., smaller or larger) relative to the width W1 of the carrier tube 34. The inner slot 120 has a substantially uniform width that is larger than the thickness of the carrier tube 34 in the flattened tube configuration. The outer slot 122 is sized and shaped to receive the liner 32 therethrough. The elongate outer slot 122 has a length that is slightly longer than the width W2 of the liner. For example, in one embodiment the length of the outer slot 122 is about 105% of the width W2 of the liner 32. The outer slot 122 can also be a different length (e.g., smaller or larger) relative to the width W2 of the liner 32. The outer slot 122 has a substantially uniform width that is larger than the thickness of the liner 32. Front and rear edges of each of the inner and outer slots 120, 122 may be beveled slightly to aid in inserting the liner 32 and carrier tube 34 through the upstream folding die 62.

The inner slot 120 has a U-shape, and the outer slot 122 has a U-shape extending partially around the inner slot. The U-shaped inner slot 120 is positioned inside the U-shaped outer slot 122. The inner slot 120 has a substantially square U-shape, with a substantially straight central segment 130 and opposite substantially straight end segments 132, 134 extending vertically from opposite ends of the central segment. The outer slot 122 has a somewhat more curved shape than the inner slot 120. The outer slot 122 has a substantially straight central segment 140 and opposite curved end segments 142, 144 extending up from opposite ends of the central segment. When the carrier tube 34 extends through the inner slot 120, the die plate 110 folds the carrier tube 34 along two spaced apart longitudinal axes into a U-shaped configuration in which the cross-sectional shape of the carrier tube on the downstream side of the folding die 62 substantially matches the shape of the inner slot. Longitudinal edge margins 150, 152 of the carrier tube 34 extend up from opposite ends of a central portion 154 of the carrier tube. When the liner 32 extends through the outer slot 122, the die plate 110 folds the liner along two spaced apart longitudinal fold axes into a U-shaped configuration in which the cross-sectional shape of the liner on the downstream side of the folding die 62 substantially matches the shape of the outer slot. As the liner 32 and carrier tube 34 are being pulled conjointly through the folding system 54, the upstream folding die 62 folds both the liner and the carrier tube from substantially planar configurations upstream of the folding die to U-shaped configurations downstream of the folding die. The upstream folding die 62 thereby transitions the liner 32 and carrier tube 34 from their initial planar configurations to a folded configuration in which the liner and carrier tube are shaped for entry into the intermediate folding die 64.

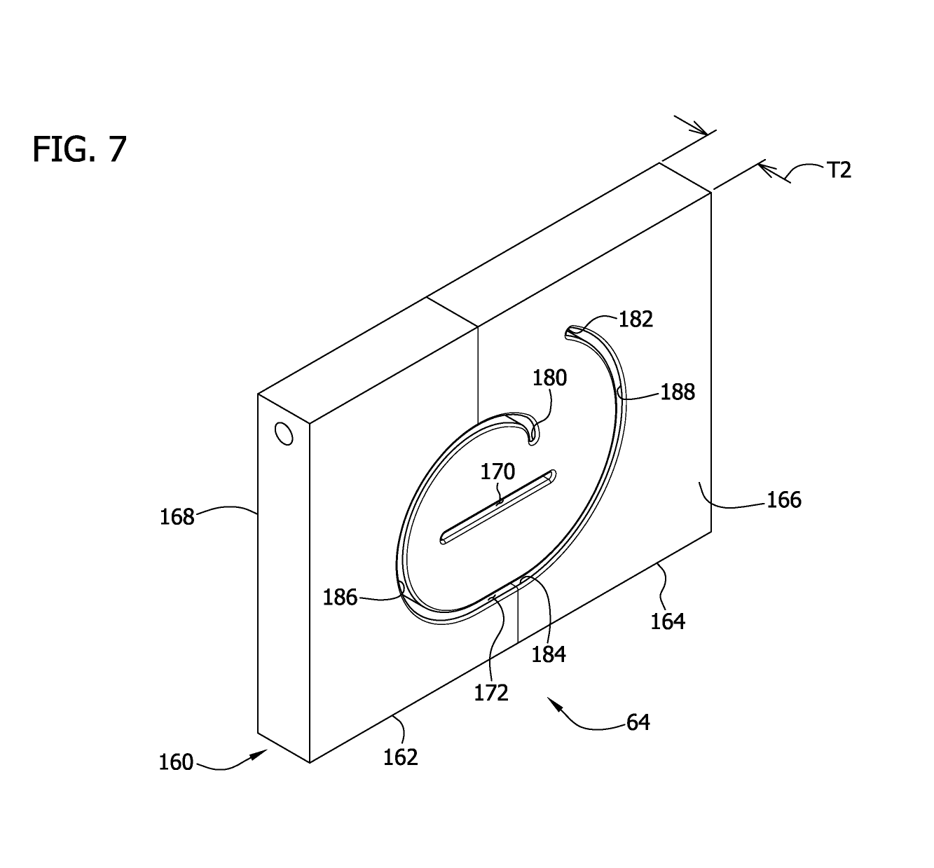

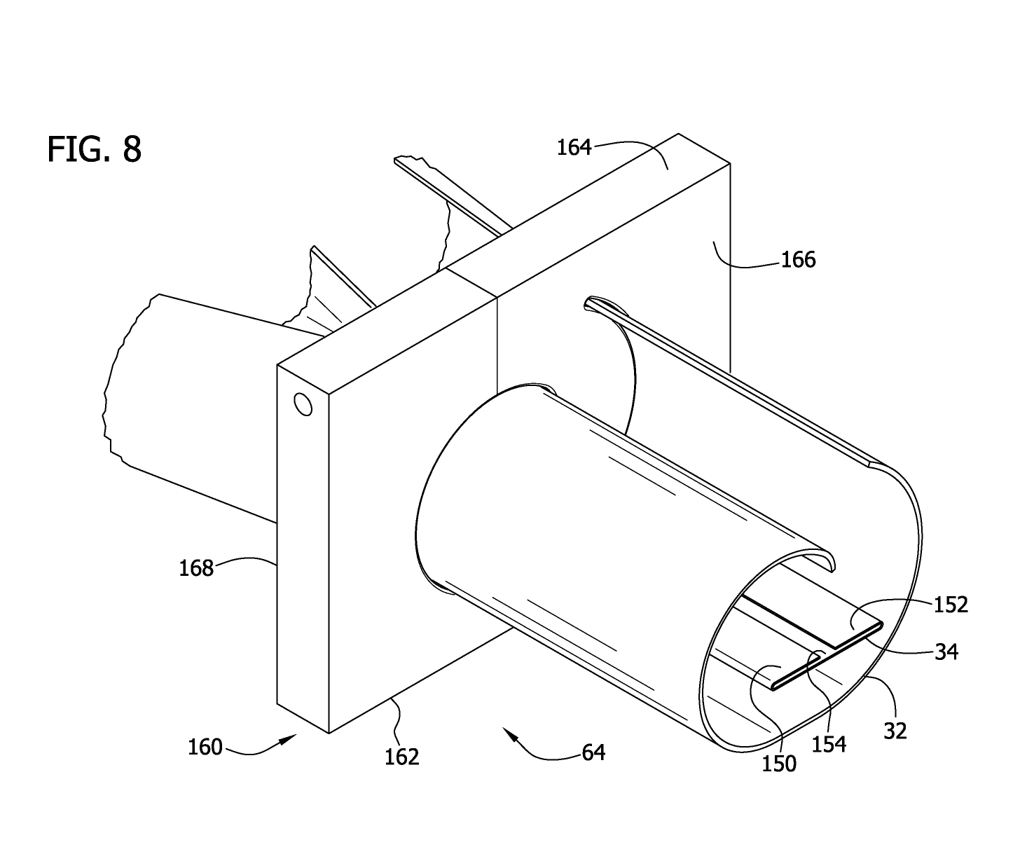

Referring to FIGS. 7-8, the intermediate folding die 64 is configured to receive the liner 32 and carrier tube 34 from the upstream folding die 52 and further fold the liner 32 and carrier tube 34 such that the liner extends once around substantially the entire perimeter of the carrier tube. The intermediate folding die 64 includes a die plate 160 comprising first and second releasably attachable plate members 162, 164. The plate members 162, 164 can be selectively attached to each other to form the die plate 160. As above, the plate members 162, 164 may be separated from one another to aid in inserting the liner 32 and carrier tube 34 into the folding die 64. It will be understood that the intermediate die plate could be constructed of other numbers of plate members (e.g., one or more) without departing from the scope of the invention.

When the plate members 162, 164 are attached to one another to form the die plate 160, the die plate has a front face 166 (which faces downstream in FIG. 4), a rear face 168 (which faces upstream in FIG. 4) opposite the front face, and a thickness T2 extending between the front and rear faces. In the illustrated embodiment, the thickness T2 is about the same as the thickness T1 of the upstream folding die 62. The die plate 160 can be made from any suitable material, including aluminum, polyethylene, steel, and other suitable polymeric or metallic materials. The die plate 110 has an elongate inner slot 170 and an elongate outer slot 172 extending through the thickness of the plate from the front face 166 through the rear face 168. The inner slot 170 is sized and shaped to receive the carrier tube 34 therethrough in a folded configuration as illustrated in FIG. 8. Preferably, the inner slot 170 has a length that is shorter than the width W1 of the carrier tube 34 in the flattened tube configuration. In the illustrated embodiment, the inner slot 170 is about 0.53-times as long as the width W1 of the carrier tube 34. The inner slot 170 can also have a different length (e.g., longer or shorter) relative to the width W1 of the carrier tube. The inner slot 170 has a substantially uniform width that is more than twice as large as the thickness of the carrier tube 34 in the flattened tube configuration. The outer slot 172 is sized and shaped to receive the liner 32 therethrough. The elongate outer slot 172 has a length that is slightly longer than the width W2 of the liner 32. For example, in one embodiment the length of the outer slot 172 is about 105% of the width W2 of the liner 32. The outer slot 172 can also be a different length (e.g., smaller or larger) relative to the width W2 of the liner 32. The outer slot 172 has a substantially uniform width that is larger than the thickness of the liner 32. Front and rear edges of each of the inner and outer slots 170, 172 may be beveled slightly to aid inserting the liner 32 and carrier tube 34 through the intermediate folding die 64.

The inner slot 170 is substantially straight. When the carrier tube 34 extends through the inner slot 170, the die plate 160 folds the carrier tube into a “folded-over configuration” in which each of the longitudinal edge margins 150, 152 of the carrier tube overlie the central portion 154 of the carrier tube in overlapping engagement therewith. As pull rope 30 pulls the liner 32 and carrier tube 34 conjointly through the folding system 54 and into the host pipe 10, the intermediate folding die 62 folds the carrier tube 34 along two spaced apart longitudinal fold axes from a configuration in which the carrier tube has a U-shaped cross-sectional shape to the folded-over configuration in which the longitudinal edge margins 150, 152 lie substantially flat against the central portion 154 of the carrier tube and in which the carrier tube is shaped for entry into the downstream folding die 66. In combination, the upstream folding die 62 and the intermediate folding die 64 function, in part, to lessen the width of the carrier tube 34 by about half.

The outer slot 172 is generally shaped like a spiral that winds about once around the perimeter of the inner slot 170. The outer slot has opposite first and second ends 180, 182 that are positioned adjacent one another in a substantially non-overlapping position. The outer slot 172 has a central segment 184 that is spaced apart from the inner slot 170 and extends substantially parallel to the inner slot. A first curved segment 186 extends from one end of the central segment 184 to the first end 180, and a second curved segment 188 extends from the opposite end of the central segment to the second end 182. The first curved segment 186 curves more than the second curved segment 188 such that the first end 180 of the outer slot 172 is closer to the inner slot 170 than the second end 182 of the outer slot. When the liner 32 extends through the outer slot 172, the die plate 160 folds the liner to wrap the liner circumferentially around the carrier tube 34. The cross-sectional shape of the liner 32 adjacent the downstream side of the intermediate folding die 64 substantially matches the shape of the outer slot 172. Longitudinal edges of the liner 32 adjacent the downstream side of the intermediate folding die 64 do not overlap one another. As the pull rope 30 pulls the liner 32 and carrier tube 34 conjointly through the folding system 54 and into the host pipe 10, the intermediate folding die 64 folds the liner 32 from a configuration in which the liner has a U-shaped cross-sectional shape to a configuration in which the liner 32 has a generally spiral-shaped cross-sectional shape and in which the liner is shaped for entry into the downstream folding die 66.

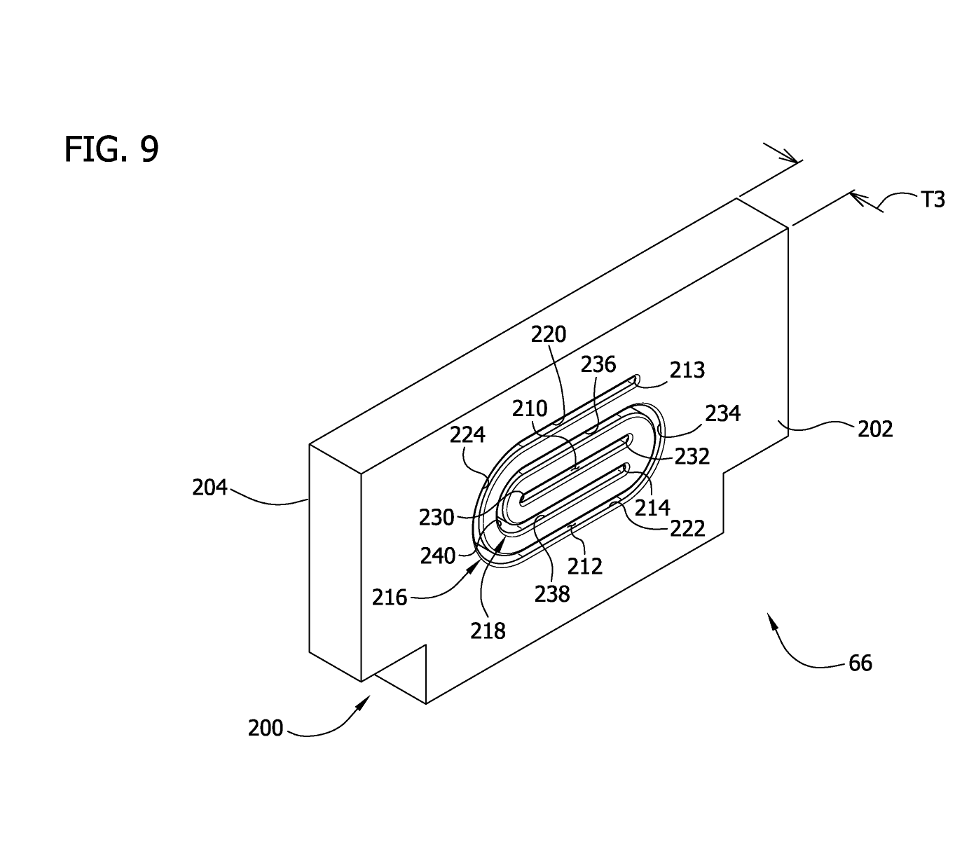

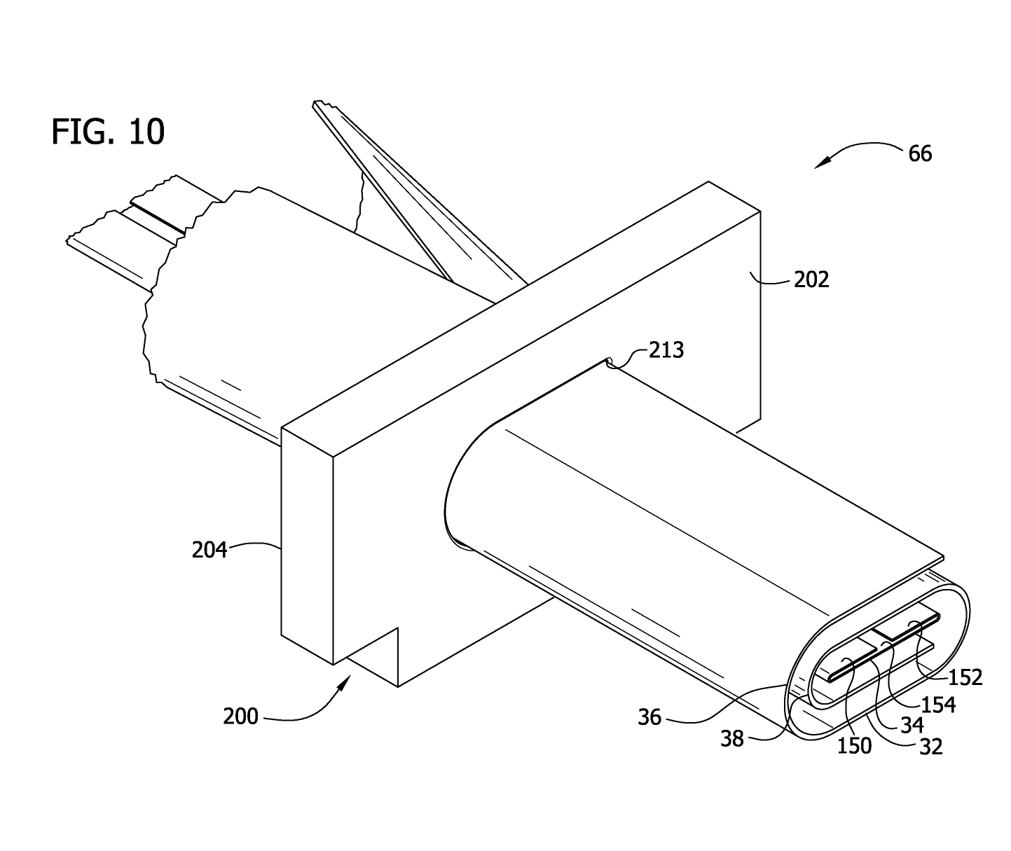

Referring to FIGS. 9-10, the downstream folding die 66 is configured to receive the liner 32 and carrier tube 34 from the intermediate folding die 64 and further fold the liner to wrap the liner around the carrier tube as the liner and carrier tube are being pulled conjointly through the folding system 54 and into the host pipe 10. The downstream folding die 66 includes a one-piece die plate 200. It will be understood that the downstream die plate could be constructed as a multi-piece assembly without departing from the scope of the invention. The die plate 200 has a front face 202 (which faces downstream in FIG. 4), a rear face 204 (which faces upstream in FIG. 4) opposite the front face, and a thickness T3 extending between the front and rear faces. In the illustrated embodiment, the thickness T3 is about the same as the thicknesses T1, T2 of the upstream and intermediate folding dies 62, 64. The die plate 200 can be made from any suitable material, including aluminum, polyethylene, steel, and other suitable polymeric materials.

The die plate 200 has an elongate inner slot 210 and an elongate outer slot 212 extending through the thickness T3 of the plate from the front face 202 through the rear face 204. The inner slot 210 is sized and shaped to receive the carrier tube 34 therethrough. The inner slot 210 is substantially identical in size and shape to the inner slot 170 of the intermediate folding die 64. The outer slot 212 is sized and shaped to receive the liner 32 therethrough. The elongate outer slot 212 has a length that is slightly longer than the width W2 of the liner 32. For example, in one embodiment the length of the outer slot 212 is about 105% of the width W2 of the liner 32. The outer slot 212 can also be a different length (e.g., smaller or larger) relative to the width W2 of the liner 32. The outer slot 212 has a substantially uniform width that is larger than the thickness of the liner 32. Front and rear edges of each of the inner and outer slots 210, 212 may be beveled slightly to aid inserting the liner 32 and carrier tube 34 through the downstream folding die 66.

The inner slot 210 is substantially straight. When the carrier tube 34 extends through the inner slot 210, the die plate 200 engages the carrier tube to retain the carrier tube in the folded-over configuration in which the carrier tube extends from the intermediate folding die 64. The folding die 66 folds the carrier tube 34 so that longitudinal edge margins 150, 152 of the carrier tube overlie the central portion 154 of the carrier tube in overlapping engagement therewith. As pull rope 30 pulls the liner 32 and carrier tube 34 conjointly through the folding system 54 and into the host pipe 10, the downstream folding die 66 holds the carrier tube 34 in the folded-over configuration it had exiting intermediate folding dies 66 in which the longitudinal edge margins 150, 152 lie substantially flat against the central portion 154 of the carrier tube and in which the carrier tube is shaped for entry into the host pipe 10.

In the illustrated embodiment, the outer slot 212 is shaped like a conventional paper clip. The outer slot 212 extends around the inner slot 210 from a first end 213 to a second end 214 opposite the first end. The outer slot has a first overlapping section, generally indicated at reference number 216, adjacent the first end 213, and a second overlapping section, generally indicated at reference number 218, adjacent the second end 214. The second overlapping section 218 is positioned between the first overlapping section 216 and the inner slot 210.

In the illustrated embodiment, the first overlapping section 216 of the outer slot 212 includes a first exterior segment 220, a second exterior segment 222, and a first connecting segment 224 extending between and connecting the first exterior segment and the second exterior segment. Each of the first and second exterior segments 220, 222 is substantially straight and extends substantially parallel to the inner slot 210, as well as substantially parallel to the other of the first and second exterior segments. The first exterior segment 220 is spaced apart from a top side of the inner slot, and the second exterior segment 222 is spaced apart from a bottom side of the inner slot. The first connecting segment 224 curves from the first exterior segment 220 to the second exterior segment 222. The first connecting segment 224 is spaced apart from a first end 230 of the inner slot 210. Spaced apart from a second end 232 of the inner slot 210, a curved second connecting segment 234 connects the first overlapping portion 216 of the outer slot 212 to the second overlapping portion 218.

The second overlapping portion 218 of the outer slot 212 includes a first interior segment 236, a second interior segment 238, and a third connecting segment 240 extending between and connecting the first interior segment and the second interior segment. Each of the first and second interior segments 236, 238 is substantially straight and extends substantially parallel to the inner slot 210 and exterior segments 220, 222, as well as substantially parallel to the other of the first and second interior segments. The first interior segment 236 is positioned between and spaced apart from the first exterior segment 220 of the outer slot 212 and the top side of the inner slot 210. Likewise, the second interior segment 238 is positioned between and spaced apart from the second exterior segment 222 of the outer slot 212 and the bottom side of the inner slot 210. The third connecting segment 240 curves from the first interior segment 236 to the second interior segment 238. The third connecting segment 240 is positioned between and spaced apart from the first end 230 of the inner slot 210 and the first connecting segment 224 of the outer slot 212.

In the illustrated embodiment, each of the first and second overlapping sections 216, 218 is substantially C-shaped and bounds a respective interior region. The second overlapping section 218 is nested in the interior region defined by the first overlapping section 216, and the inner slot 210 is nested in the interior region defined by the second overlapping section. Although the illustrated outer slot 212 is shaped to define two nested, C-shaped overlapping sections 216, 218, it will be understood that other embodiments may be shaped and arranged differently to define overlapping sections of different shapes and arrangements. For example, it is expressly contemplated that the second interior segment 238 and third connecting section 240 of the outer slot 212 could be omitted from the downstream folding die 66 without departing from the scope of the invention. In such an embodiment, the first exterior segment 220 and the first interior segment 236 would form the overlapping sections 216, 218 of the outer slot 212.

As shown in FIG. 10, the inner slot 210 is configured to receive the carrier tube 34 therethrough and the outer slot 212 is configured to receive the liner 32 therethrough and to fold the liner in the “pull-in configuration” in which the liner wraps around the carrier tube. When the liner 32 extends through the outer slot 212, the first overlapping portion 36 of the liner is received in the first overlapping section 216 of the outer slot and the second overlapping portion 38 of the liner is received in the second overlapping section 218 of the outer slot. As the pull rope 30 pulls the liner 32 through the outer slot 210, the die plate 200 folds the liner along first, second, and third longitudinal axes that are respectively centered in each of the first, second, and third curved connecting segments 224, 234, 240 to position the first overlapping portion 36 of the liner in overlapping engagement with the second overlapping portion 38 of the liner. The die plate 200 folds the first overlapping portion 36 of the liner 32 to have a C-shaped cross-sectional shape and folds the second overlapping portion 38 of the liner to have a C-shaped cross-sectional shape that is nested within the first overlapping portion in overlapping engagement therewith. As the pull rope 30 pulls the liner 32 and carrier tube 34 conjointly through the downstream folding die 66, the die plate 200 folds the liner so that the second overlapping portion 38 is positioned between the first overlapping portion 36 and the carrier tube. The second overlapping portion 38 of the liner 32 wraps around the carrier tube 34 as the liner and carrier tube exit the folding die 66. The downstream folding die 66, thus, folds the liner 32 to shape the liner in a final folded pull-in configuration in which the liner has a cross-sectional shape that substantially matches the shape of the outer slot 212.

By folding the liner 32 and retaining the carrier tube 34 in the overlapping folded configuration as described above, the downstream folding die 66 shapes the liner and carrier tube for being pulled into the host pipe 10. As the pull rope 30 pulls the liner 32 and carrier tube 34 conjointly into the host pipe 10, engagement between a bottom surface of the liner 32 and the interior surface 16 of the host pipe 10, as shown in FIG. 3A, creates friction, which makes pull in more difficult. The amount of friction increases the larger the engagement area between the liner 32 and interior surface 16. But the downstream folding die 66 wraps the liner 32 around the carrier tube 34 by folding the liner along three spaced apart longitudinal axes. As a result, the width of the liner 32 in the folded pull-in configuration is substantially less than the width of the liner in a planar configuration (or another folded configuration in which the liner is folded along less than three longitudinal fold axes).

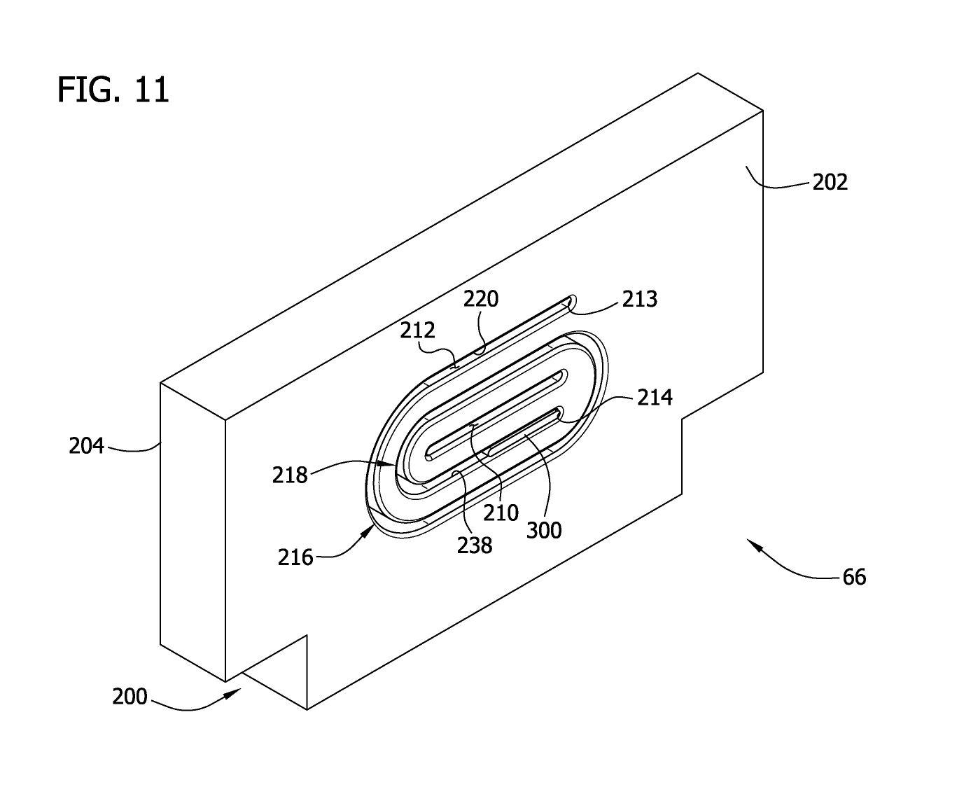

Although the folding dies 62, 64, 66 may be used with a liner 32 that has a width W2 that is nearly as long as the length of the elongate slots 122, 172, 212, the folding dies may also be used with to fold liners of considerably lesser widths. When liners of lesser widths are used, it is desirable to properly position the liner along the length of the respective slot 122, 172, 212. For example, for the downstream folding die 66, it is desirable to position the liner so one longitudinal edge of the liner is positioned adjacent the first end 213 of the outer slot 212. As shown in FIG. 11, in one embodiment, a spacer 300 is positioned in in the slot 212 adjacent the second end 214 (i.e., in the second interior segment 238). One end of the spacer 300 engages the second end 214 of the slot 212 and the opposite end of the spacer inhibits a longitudinal edge of the liner from sliding toward the second end of the slot as it is pulled through the folding die 66. If a centered position is desired, a second spacer may be positioned near the first end 213. Similar spacers (not shown) may be used to position a liner of significantly lesser widths than the elongate outer slots 122, 172 in the desired positions within the slots.

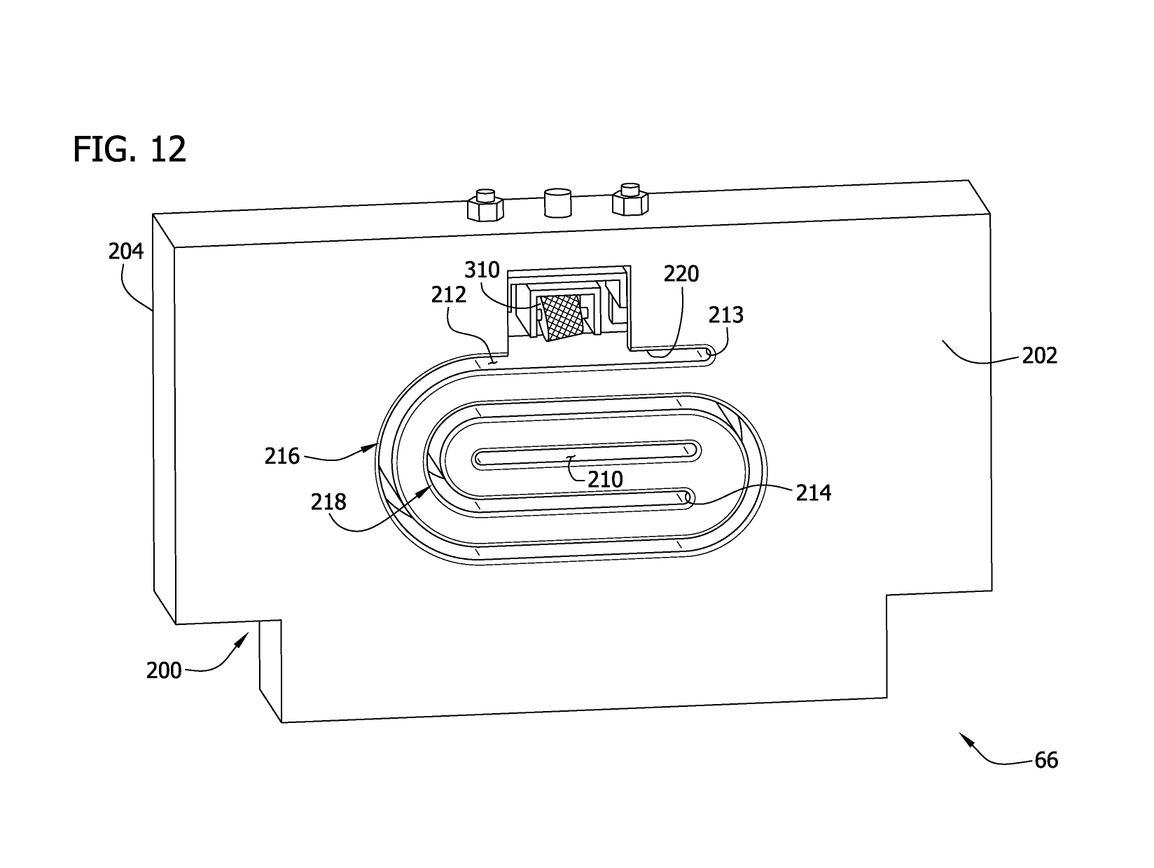

In another embodiment illustrated in FIG. 12, a roller 310 is mounted on the die plate 200 for rotation. The roller 310 extends into the first exterior segment 220 of the outer slot 212 to engage a liner (not shown) extending through the slot. In a preferred embodiment, the roller 310 is operably connected to a compressed air piston or spring that biases the roller toward engagement with the liner 32. The engagement between the roller 310 and liner causes the roller to roll along the surface of the liner as the pull rope 30 pulls the liner through the slot 212. In the illustrated embodiment, the annular surface of the roller 310 is knurled to enable the roller to grip the fabric as it rolls. The engagement between the roller 310 and the liner 32 inhibits the liner 32 from shifting laterally within the outer slot 212 away from the first end 213 as the pull rope 30 pulls the liner 32 through the folding die 66. The roller 310 may be mounted on a skew angle (i.e., the axis of rotation of the roller may be non-parallel) with respect to the longitudinal axis of the first exterior segment 220 of the outer slot 212 to urge the liner toward the first end 213 as the liner is pulled through the folding die. The roller 32 may be skewed vertically, such that the axis of the rotation is oriented at a non-parallel angle relative to the longitudinal axis of the exterior segment 220 in a vertical plate. Or the roller may be skewed in the pull-through direction, in which case the axis of rotation is oriented at a non-parallel angle relative to the longitudinal axis of the exterior segment 220 in a horizontal plane. It will be understood that one or more rollers may be similarly mounted in other segments of the outer slot 212 or in any segment of the outer slots 122, 172 to position the liner laterally within the respective outer slot.

An exemplary method of installing the liner 32 in the host pipe 10 will now be described in reference to a crew of pipe lining technicians that performs the method. Preferably, the crew includes no more than five technicians. However, it will be understood that larger crews may be used to perform the method without departing from the scope of the invention. In addition, certain steps of the method described as being performed by members of the pipe lining crew may also be performed by automated systems or machines without departing from the scope of the invention.

Rather than forming a combined liner and carrier tube at a dedicated manufacturing facility remote from the host pipe 10, a pipe lining crew may position the liner 32 and carrier tube 34 on separate rolls adjacent the first access point 18 to the host pipe 10 at the work site, as shown in FIG. 1. In addition, the pipe lining crew positions the wet out system 52 and folding system 54 between the free ends of the liner 32 and carrier tube 34 and the first access point 18 to the host pipe 10. When the folding system 54 is positioned between the free ends of the liner 32 and carrier tube 34 and the first access point 18 to the host pipe 10, the folding dies 62, 64, 66 are likewise positioned between the free ends of the liner and carrier tube and the first access point to the host pipe. In certain embodiments, the crew may position terminal coupling members 57 (FIG. 3A) generally end to end with the ends of the host pipe 10. Likewise, the crew may position sacrificial end tubes 59 generally end to end with either the ends of the host pipe 10 or the ends of the terminal coupling members 57. The crew preferably inserts the pull rope 30 through the host pipe 10 from the second access point 20 through the first access point 10 using a suitable technique.

Referring to FIGS. 3 and 4, when the crew has finished positioning the liner 32, carrier tube 34, wet out system 52 and folding system 54, the crew feeds the free end of the liner through the wet out system. The crew likewise pulls the free end of the carrier tube 34 toward the upstream end of the folding table 60 to prepare the carrier tube for folding. The wet out system 52 impregnates the liner with curable epoxy as the liner passes through the wet out system. The liner 32 exits the wet out system in a planar configuration. With the free ends of the liner 32 and carrier tube 34 positioned adjacent the upstream end of the folding table 60, one or more members of the crew feed the free end of the liner through the U-shaped outer slot 122 in the upstream folding die 62 and feed the free end of the carrier tube through the U-shaped inner slot 120 in the upstream folding die. Once the liner 32 and carrier tube 34 have been fed through the upstream folding die 62, one or more members of the pipe lining crew pull the free ends of the liner and carrier tube toward the intermediate folding die 64. As the crew members pull the carrier tube 34 in the downstream direction, the upstream folding die 62 folds the liner 32 and carrier tube 34 from a respective planar configuration upstream of the folding die to a respective U-shaped configuration on the downstream side of the folding die.

One or more crew members feed the free end of the liner 32 through the spiral-shaped outer slot 172 in the intermediate folding die 64 and feed the free end of the carrier tube 34 through the substantially straight outer slot 170 in the intermediate folding die. The crew members manipulate the longitudinal edge margins 150, 152 of the carrier tube 34 to fold them flat against the central portion 154 before feeding the carrier tube through the slot 170. Once the liner 32 and carrier tube 34 have been fed through the intermediate folding die 64, one or members of the pipe lining crew pull the free ends of the liner and carrier tube toward the downstream folding die 66. As the crew members pull the carrier tube 34 in the downstream direction, the intermediate folding die 64 folds the liner 32 from a U-shaped configuration upstream of the folding die to a spiral configuration downstream of the folding die. The intermediate folding die 64 likewise folds the carrier tube 34 from a U-shaped configuration upstream of the folding die to a folded-over configuration downstream of the folding die.

After inserting the free ends of the liner 32 and carrier tube 34 through the intermediate folding die 64, one or more crew members feed the free end of the liner through the outer slot 212 in the downstream folding die 66 and feed the free end of the carrier tube through the inner slot 210 in the downstream folding die. Little manipulation of the carrier tube 34 is needed between the intermediate folding die 64 and downstream folding die 66 because, in the illustrated embodiment, the carrier tube extends through the inner slot 210 in the downstream folding die in the same folded-over configuration in which it also exits the inner slot 170 of the intermediate folding die. To feed the liner 32 through the outer slot 212 in the downstream folding die 66, one or more members of the crew shape the second overlapping portion 38 of the liner to conform to the shape of the second overlapping section 218 of the outer slot 212 and shape the first overlapping portion 36 of the liner to conform to the shape of the first overlapping section 216 of the outer slot. Once the liner 32 and carrier tube 34 have been fed through the intermediate folding die 64, one or members of the pipe lining crew pull the free ends of the liner and carrier tube toward guide chute 56. The liner 32 and carrier tube 34 may be threaded separately through the folding dies 62, 64, 66 or in any suitable order.

Either before or after pulling the free ends of the liner 32 and carrier tube 34 through the guide chute 56, one or more members of the pipe lining crew attach the free ends of the liner 32 and carrier tube 34 to the pull rope 30, for example via a clamp fitting (not shown). Preferably, a winch or other pulling device pulls the pull rope 30, the liner 32, and the carrier tube 34 conjointly into and through the host pipe 10, from the first access point 18 to the second access point 20. If coupling members 57 are used, the pull rope 30 likewise pulls the liner 32 and carrier tube 34 through the coupling members 57. Similarly, if sacrificial end tubes 59 are used, the pull rope 30 pulls the liner 32 and carrier tube 34 through the sacrificial end tubes. As the pull rope 30 pulls the liner 32 and carrier tube 34 conjointly through the host pipe 10, the upstream, intermediate, and downstream folding dies 62, 64, 66 incrementally fold the liner and carrier tube. The upstream and intermediate folding dies 62, 64 continue to fold the liner 32 and carrier tube 34 as described above in reference to the crew members pulling the free ends of the liner and carrier tube between folding dies. The downstream folding die 66 folds the liner along first, second, and third spaced apart longitudinal axes centered in the connection segments 224, 234, 240 of the outer slot 212 to position the first C-shaped overlapping portion 36 of the liner in overlapping engagement with the second C-shaped overlapping portion 38 of the liner, which is nested in the first overlapping portion. The folding die 66 positions the second overlapping portion 38 between the first overlapping portion 36 and the carrier tube 34 as the pull rope 30 pulls the liner 32 and carrier tube 34 conjointly through the host pipe 10. In addition, the folding die 66 wraps the second overlapping portion 38 of the liner 32 around the carrier tube 34. As the pull rope 30 pulls the liner 32 and carrier tube 34 conjointly through the host pipe 10, it may be desirable to station one or more crew members near the folding table to reposition the liner if it shifts within any of the slots 122, 172, 212.

When the liner 32 and carrier tube 34 are positioned in the interior lumen 14 of the host pipe 10 such that each extends from the first access point 18 to the second access point 20, the carrier tube is radially expanded to install the liner in the host pipe. In certain embodiments, before being radially expanded, the liner 32 and carrier tube 34 also extend through either or both of the terminal coupling members 57 and the sacrificial end tubes 59. As shown in FIGS. 2A-2C, the pipe lining crew directs a pressurized fluid into the carrier tube 34 and the carrier tube begins to expand, unfolding from the folded-over configuration as it expands. As the carrier tube 34 expands, the first overlapping portion 36 of the liner 32 slides along the second overlapping portion 28 such that the amount of overlap between the longitudinal edge margins of the liner decreases. The carrier tube 34 expands until the liner 32 contacts the entire circumference of the interior surface 16 of the host pipe. The carrier tube 34 remains in the expanded state while the curable epoxy in the liner 32 cures. In one embodiment, the curing of the curable epoxy bonds the liner 32 to the host pipe wall 12 and bonds the liner to the carrier tube 34. In another embodiment, the curing of the curable epoxy bonds the liner 32 with the carrier tube 34 but does not bond the liner to the host pipe wall 12. If terminal coupling members 57 are used, the liner 32 preferably bonds with the interior surfaces of the terminal coupling members. After curing, the crew cuts away any unwanted portions of the cured liner 32 and carrier tube to yield a lined pipe. For example, if sacrificial end tubes 59 are used, the liner crew removes the sacrificial end tubes and portions of the liner 32 and carrier tube 34 received therein. If the coupling members 57 are used, the crew may secure mechanical couplers to the coupling members to secure the lined pipe to other pipe segments.

One skilled in the art will appreciate that the systems, apparatuses, and methods described above provide a way to install planar liners made from suitable materials in host pipes that are installed in the field. The techniques described above can be performed without expensive manufacturing processes for forming a planar liner into a tube before positioning the liner at the site of a host pipe. In addition, the systems, apparatuses, and methods described above can be used by a reasonably small installation crew to effectively line host pipes.

Having described the invention in detail, it will be apparent that modifications and variations are possible without departing from the scope of the invention defined in the appended claims.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A method of lining an interior surface of a host pipe at a work site, the host pipe having a first access point, said method comprising:
positioning a pliable liner near the first access point, the liner having a first end, a second end, and a length extending between the first and second ends, the liner further having a first longitudinal edge, a second longitudinal edge, and a width extending between the first and second longitudinal edges;
positioning a radially expandable carrier tube near the first access point, the carrier tube having a first end and a second end;
positioning a folding die between the first ends of the liner and carrier tube and the first access point, the folding die being configured to receive the liner and carrier tube therethrough and to fold at least the liner for entry of the liner and carrier tube into the host pipe when the liner and carrier tube are pulled through the folding die;
feeding an end portion of the carrier tube adjacent the first end thereof through the folding die;
feeding an end portion of the liner adjacent the first end thereof through the folding die;
pulling the liner and carrier tube conjointly through the folding die and into the host pipe, the folding die folding at least the liner as the liner and carrier tube are being pulled through the folding die; and
radially expanding the carrier tube within the host pipe at least until the liner contacts the interior surface of the pipe.

2. A method as set forth in claim 1 wherein the step of pulling the liner and carrier tube includes folding the liner with the folding die along a longitudinal axis as the liner and carrier tube are being pulled through the folding die to wrap the liner around the carrier tube.

3. A method as set forth in claim 1 wherein the step of pulling the liner and carrier tube includes folding the liner with the folding die along a longitudinal axis as the liner and carrier tube are being pulled through the folding die to position a first overlapping portion adjacent the first longitudinal edge of the liner in overlapping engagement with the second overlapping portion adjacent the second longitudinal edge of the liner.

4. A method as set forth in claim 3 wherein the step of folding the liner with the folding die comprises folding the liner so the first overlapping portion has a C-shaped cross-sectional shape and the second overlapping portion has a C-shaped cross-sectional shape and is nested in the first overlapping portion as the liner and carrier tube are being pulled through the folding die.

5. A method as set forth in claim 1 further comprising loading the liner with a curable material at a location near the first access point of the host pipe.

6. A method as set forth in claim 5 wherein the step of loading the liner with the curable material is carried out at the same time as the step of pulling the liner and carrier tube conjointly through the folding die and into the host pipe.

7. A method as set forth in claim 1 wherein said folding die comprises a final folding die and said method further comprises:
positioning an upstream folding die between the first ends of the liner and carrier tube and the final folding die, the upstream folding die being configured to receive the liner and carrier tube therethrough and to fold at least the liner for entry of the liner and carrier tube into the final folding die;
wherein said pulling step comprises pulling the carrier tube and liner conjointly through the upstream folding die and final folding die, the upstream folding die folding at least the liner as the liner and carrier tube are pulled through the initial folding die.

8. A method as set forth in claim 1 wherein the step of pulling the liner and carrier tube further comprises pulling the liner and carrier tube conjointly through a guide chute positioned between the folding die and the host pipe.

9. A method as set forth in claim 1 further comprising positioning a sacrificial end tube generally end to end with an end of the host pipe;
pulling the liner and carrier tube into the sacrificial end tube; and
removing the sacrificial end tube and portions of the liner and carrier tube located therein.

10. A folding die for folding a liner along a longitudinal axis to wrap the liner around a carrier tube as the liner and carrier tube are being pulled conjointly through the folding die and into a host pipe, the folding die comprising a die plate having a front face, a rear face opposite the front face, and a thickness extending between the front face and rear face, the plate having an elongate inner slot and an elongate outer slot extending through the thickness of the plate from the front face through the rear face, the outer slot extending around the inner slot from a first end to a second end opposite the first end and having a first overlapping section adjacent the first end and a second overlapping section adjacent the second end, the first overlapping section overlapping the second overlapping section such that the second overlapping section is positioned between the first overlapping section and the inner slot, the inner slot being configured to receive the carrier tube therethrough and the outer slot being configured to receive the liner therethrough such that a first overlapping portion of the liner is received in the first overlapping section of the outer slot and a second overlapping portion of the liner is received in the second overlapping section of the outer slot, the folding die being configured to wrap the liner around the carrier tube and position the first overlapping portion of the liner in overlapping engagement with the second overlapping portion of the liner as the liner and carrier tube are pulled conjointly through the folding die and into the host pipe.

11. A folding die as set forth in claim 11 wherein the outer slot comprises first and second exterior segments spaced apart from opposite sides of the inner slot and at least one interior segment positioned between the first exterior segment and the inner slot, the first overlapping section including the first exterior segment and the second overlapping section including said one interior segment.

12. A folding die as set forth in claim 11 wherein the outer slot comprises first and second interior segments, the first interior segment being positioned between the first exterior segment and one side of the inner slot and the second interior segment being positioned between the second exterior segment and an opposite side of the inner slot, the first overlapping section including the first and second exterior segments and the second overlapping section including the first and second interior segments.

13. A folding die as set forth in claim 12 wherein the inner slot, the first and second exterior segments of the outer slot, and the first and second interior segments of the outer slot are substantially straight and oriented substantially parallel to one another.

14. A folding die as set forth in claim 10 wherein the outer slot comprises:
a first exterior segment spaced apart from a first side of the inner slot;
a second exterior segment spaced apart from a second side of the inner slot;
a first interior segment positioned between and spaced apart from the first side of the inner slot and the first exterior segment;
a second interior segment positioned between and spaced apart from the second side of the inner slot and the second exterior segment;
a first connecting segment connecting the first exterior segment to the second exterior segment and being spaced apart from a first end of the inner slot;
a second connecting segment connecting the second exterior segment to the first interior segment and being spaced apart from a second end of the inner slot; and
a third connecting segment connecting the first interior segment to the second interior segment and being positioned between and spaced apart from the first end of the inner slot and the first connecting segment.

15. A folding die as set forth in claim 14 wherein the first overlapping section includes the first exterior segment, first connecting segment, and second exterior segment and the second overlapping section includes the first interior segment, third connecting segment, and second interior segment.

16. A folding die as set forth in claim 10 wherein each of the first and second overlapping sections is substantially C-shaped and bounds a respective interior region, the second overlapping section being nested in the interior region defined by the first overlapping section and the inner slot being nested in the interior region defined by the second overlapping section.

17. A folding die as set forth in claim 10 further comprising a roller mounted on the plate for rotation and extending into the outer slot to engage the liner and roll along a surface of the liner as the liner is pulled through the folding die, thereby inhibiting the liner from shifting laterally within the outer slot away from the first end as the liner is pulled through the folding die.

18. A folding die as set forth in claim 17 wherein the roller rotates about an axis of rotation oriented at a non-parallel angle with respect to the outer slot to drive the liner toward the first end of the slot as the liner is pulled through the folding die.

19. A set of folding dies for incrementally folding a liner and carrier tube for entry of the liner and carrier tube into a host pipe as the liner and carrier tube are pulled conjointly through the set of folding dies and into the host pipe, the set of folding dies comprising the folding die of claim 10 configured to be the downstream folding die of the set of folding dies to fold the fabric before the fabric enters the carrier tube.

20. A set of folding dies as set forth in claim 19 further comprising an upstream folding die comprising a die plate having an elongate inner slot and an elongate outer slot, the inner slot having a U-shape and the outer slot having a U-shape extending partially around the inner slot, the inner slot being configured to receive the carrier tube therethrough to fold the carrier tube in a U-shape, the outer slot being configured to receive the liner therethrough to fold the liner in a U-shape.

21. A set of folding dies as set forth in claim 19 further comprising an intermediate folding die comprising a die plate having an elongate inner slot and an elongate outer slot, the inner slot being substantially straight and the outer slot extending once around substantially the entire perimeter of the inner slot such that first and second ends of the outer slot are positioned adjacent one another in a substantially non-overlapping position, the inner slot being configured to receive the carrier tube therethrough to fold the carrier tube such that opposite longitudinal edge margins of the carrier tube overlap and engage a central portion of the carrier tube, the outer slot being configured to receive the liner therethrough to fold the liner to wrap circumferentially around the carrier tube.
